(19) United States
(12) Patent Application Publication
(10) Pub. No.: US 2012/0060823 A1
(43) Pub. Date: Mar. 15, 2012

(54) ELEMENT AND METHOD FOR A FIRE-LIGHTING SYSTEM

(75) Inventors: Jose Armangue Casademont, Pineda De Mar (ES); Pedro Juli Soler, Pineda De Mar (ES)

(73) Assignee: JOSPER, S.A., Pineda De Mar (ES)

(21) Appl. No.: 13/057,687

(22) PCT Filed: Aug. 6, 2008
(86) PCT No.: PCT/ES2008/070155

§ 371 Date: Feb. 4, 2011

(51) Int. Cl. A47J 37/07

(52) U.S. Cl. 126/25 B

(57) ABSTRACT

Element of a fire-lighting system of an oven-grill that uses one or more firelighters and fire-lighting method in an oven-grill. Said element of the lighting system comprises an air inlet from a draught system, at least one conduit connected to said air inlet and arranged for guiding an air current to at least one firelighter, in which said air conduit includes at least one tube that has a first end connected to the air inlet and a second end, said second end of said tube having a holder arranged in such a manner as to position at least one firelighter, substantially covering the outlet surface of said second end such that said air current is concentrated in order to strike said firelighter. In this way, the coal-combustion process in the oven-grill is rapidly initiated.

### FIELD OF THE INVENTION

The present application refers to ovens of the closed barbecue type. Said ovens use combustion of charcoal, wood or any other raw material to grill, warm or cook food providing a double oven and grill function.

### BACKGROUND OF THE INVENTION

For the purposes of the present application, said ovens of the closed barbecue type will be referred to as grill ovens, or grill-ovens.

Said grill ovens, see FIG. 4, are known to operate by a system made of adjustable vents. Air inlets of the vent system typically comprise a number of holes at the lower or at bottom part of the oven. The vent system generates an air draft that goes through the oven. Combustion gases and smoke leave said oven through an outlet preferably at the top part of the oven.

Charcoal or any other suitable combustion material is placed on a combustion rack (40) above the air inlets. Said combustion rack is preferably made of cast-iron grades.

At the front of the oven there is a hinged door (41) for introducing food on one or more grill racks placed above the burning charcoal.

For operating the grill oven, charcoal (42) is introduced inside the oven onto the combustion rack. Charcoal (42) is typically three, is distributed in said pile.

Firelighters pads (43) are fire igniters. They are made of a light inflammable material that can easily be ignited by a small flame or a single match. Said firelighters pads (43) and their use as fire igniters is known in the field.

A standard lighting method for lighting fire in the oven is depicted in FIG. 4. Lighting the charcoal (42) normally requires two or three firelighter pads (43). One firelighter pad (43) will be placed at the center of the charcoal pile, while the other two would need to be positioned at the sides of said pile in an orderly fashion. Fire ignition is not an easy task for the operator who must foresee the amount of charcoal present in the grill oven, its piling disposition and determine the number and exact location of said firelighter pads (43) before lighting the fire.

Charcoal (42) will need quite some time to catch fire and start burning. The fire lighting process is traditionally slow. It may also happen that the pads are fully consumed before the charcoal (42) has caught fire. This would require a extra dose of firelighters to be used.

Another disadvantage of the prior art is the uneven distribution of flame power. An uneven arrangement of fire lighting pads (43) may cause that part of the charcoal surface to be ignited will not receive enough flame power.

The object of the present invention is to overcome at least one of the disadvantages of the prior art.

### SUMMARY OF THE INVENTION

In the present invention an air draft is forced to concentrate on the firelighter pad so as to increases the amount of oxygen that the combustion pad receives. The effect of the above is an enhanced burning pattern on the firelighter pad, which in turn results in a enhanced flame that will quickly ignite the charcoal or other burning material.

The air intake is typically a hole leading into a number of tubes, be it of circular, rectangular or oval cross section shape. Preferably the tubes are distributed in such a matter so as to concentrate onto at least one firelighter pad rack below the combustion grate in a uniform way.

### FIGURES

FIG. 1a shows the fire lighting system of the present invention comprising a tube having a an air inlet or intake.

FIG. 1b shows the fire lighting system of the present invention comprising a tube connected to an air intake with a door for air draft regulation.

FIG. 2a shows an embodiment of the present invention comprising one tube.

FIG. 2b shows an embodiment of the present invention comprising two tubes.

FIG. 2c shows a embodiment of the invention comprising three tubes.

FIG. 2d shows an embodiment of the invention comprising a square crossed section of two tubes.

FIG. 3a shows a grill oven with a lower drawer containing the fire lighting system of the invention.

FIG. 3b shows a grill oven with a lower drawer containing the fire lighting system of the invention with a drawer in its closed position inside the oven.

FIG. 3c shows an oven with a lower drawer containing the fire lighting system of the invention with a drawer in its closed position inside the drawer and a door at the front surface of the drawer for air draft regulation.

FIG. 4 shows a grill oven fire lighting system of the prior art that shows a charcoal pile with fire lighting pads.

### DESCRIPTION OF THE PREFERRED EMBODIMENTS

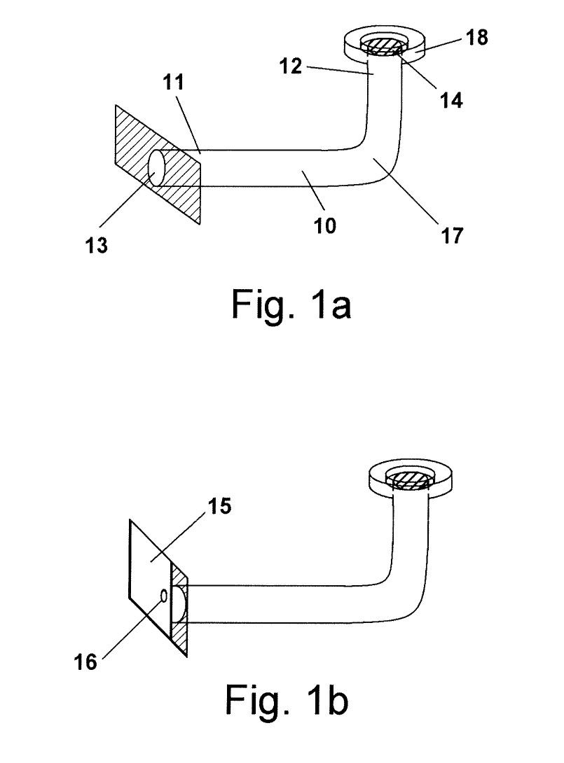

In the embodiment corresponding to FIG. 1a, a tube (10) is depicted which may have a uniform cross section of circular, rectangular or any other suitable form for allowing air draft circulation. A first end (11) of said tube (10) is attached, welded or built integrally on an air inlet or intake (13). At the first end (11) of the tube (10) a first part of the tube is arranged in the horizontal direction. At a second end (12) of the tube (10) a vertical part of the tube is arranged, said second end (12) further comprises a support (14) for the fire lighting pad, said support being preferably a grid covering the entire cross section of the tube (10). An elbow joints the horizontal and the vertical parts of the tube.

In the embodiment corresponding to FIG. 1b, a door (15) is attached to the air inlet of intake (13) for regulating the air draft in the oven. A closed position of said tube will prevent any air draft and stop the combustion process in said grill oven (30). A partially opened door (15) will allow regulation of the vent system.

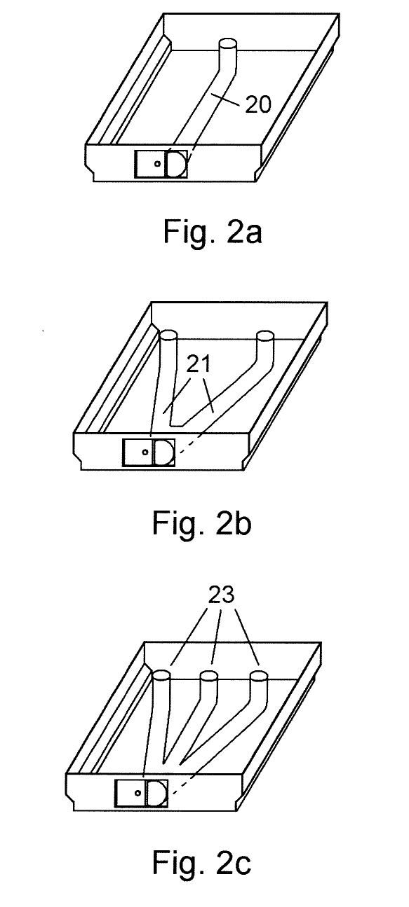

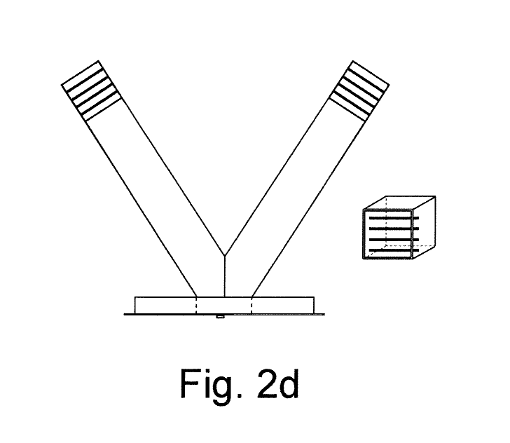

In the embodiment corresponding to FIG. 2a, a single tube (20) is depicted which may have a uniform cross section of circular, rectangular or any other suitable form for allowing air draft circulation.

Another embodiment, see FIG. 2b, shows two tubes (21) both connected to the air intake. The air draft is thereby equally divided in two shafts. At the second ends of both tubes a support for the lighting pad is built. The effect of this double tube arrangement is to distribute a fire lighting flame on the surface of a combustion rack (40) with charcoal (42) to be ignited.

In yet another embodiment, see FIG. 2c, the fire lighting system comprises three tubes (22). This system unexpectedly provides a uniform burning pattern on the combustion grates. Charcoal or other combustion materials will receive an evenly distributed flame and so charcoal will ignite in a uniform pattern in a short time.

In the embodiment of FIG. 2d, a rectangular cross section of the tube system is depicted.

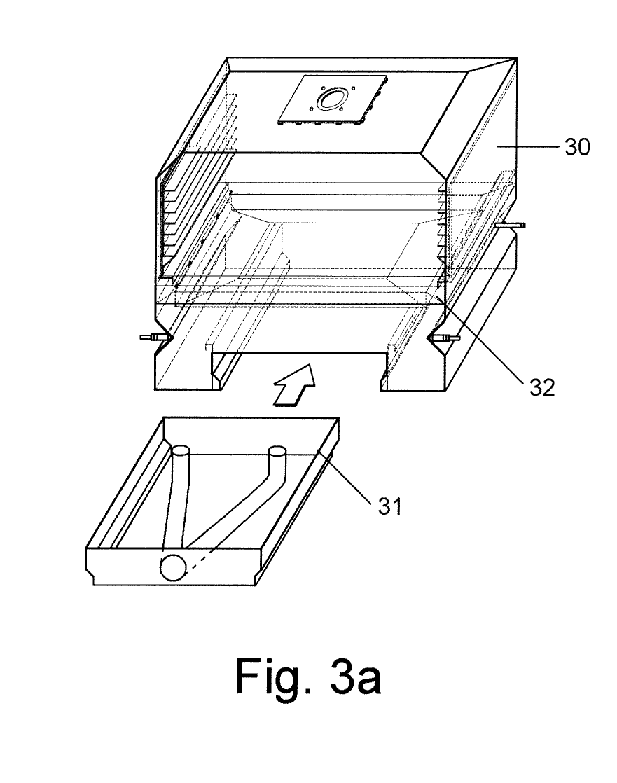

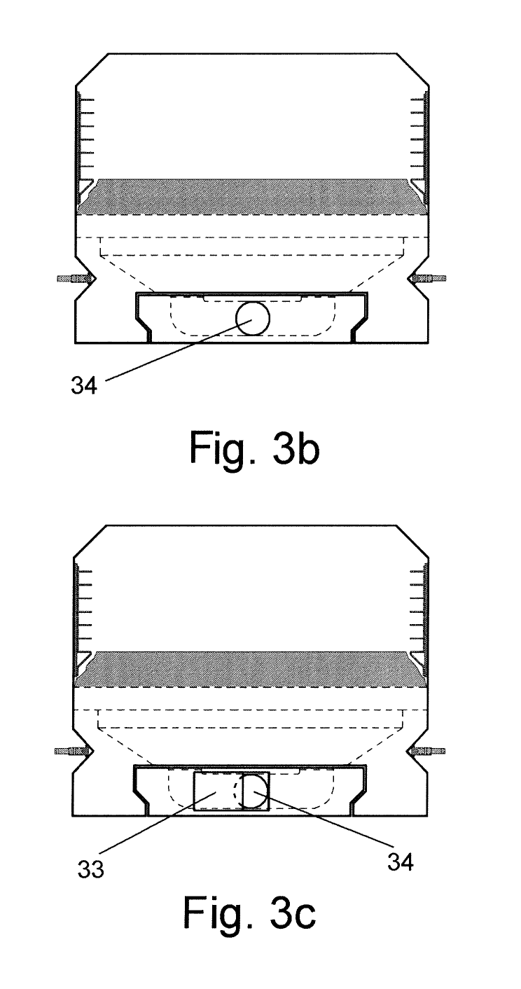

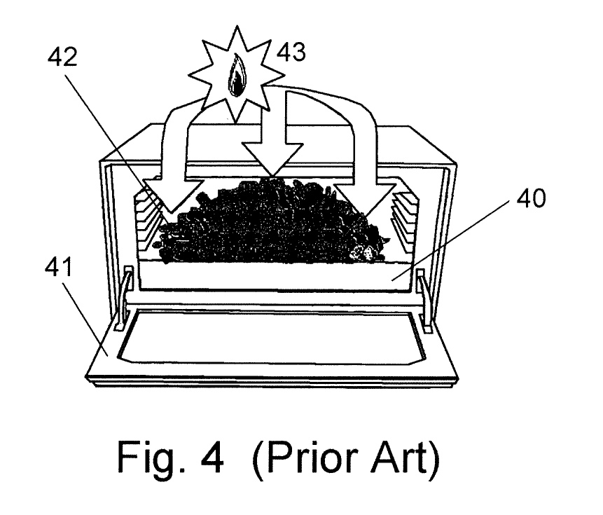

In yet another embodiment, see FIG. 3, the fire lighting system is attached to an ash box or ash drawer (31) of the grill oven.

Said ash drawer (31) is placed underneath the charcoal grates (32,40). Ashes from the combustion process of the combustion grates will fall onto said ash box (31). Once combustion in the oven is extinguished, the ash box or drawer (31) is removed for cleaning and maintenance. The lower disposition of the ash drawer (31) provides a support frame for the lighting system. Said configuration is particularly advantageous. Known ash boxes do not comprise any lighting arrangement support for the lighting pads. It is standard in the field to exclusively use the inner surface of the drawer as an ash collector. In the present embodiment of the invention, the lighting system is mounted or welded on the ash drawer itself, said ash drawer (31) thus providing physical support. This advantageous disposition requires no extra space within the grill oven (30) for the lighting system.

The ash drawer (31) comprises a front surface with a handle (16) or any other grabbing means for removing said ash drawer (31) from the grill oven (30) and for the subsequent cleaning thereof. The air vent intake of the lighting system is attached to the front surface of the drawer (31). Alternatively in the present embodiment, a number of holes may be perforated on said front surface of the ash drawer (31) and the at least one tube may be attached thereon.

The air inlet or intake (13,34) may comprise means for adjusting the air draft that enters the vent system arranged at the vicinity of the first end (11) of said tube (10). Preferably, said means comprise a door mounted on the front surface of the ash drawer (31). A handle or bolt (16) will open or partially close said door (15) so as to regulate the combustion process in the oven.

Although a door is preferred for regulating the air draft of the grill oven (30), other means achieving the same effect are known to the skilled person.

What is claimed is:

1.-12. (canceled)

13. A fire lighting system element for use with a grill oven and at least one lighting pad, the fire lighting system element comprising
an air vent inlet,
at least one tube having a first end coupled to the air vent inlet and a second end having an outlet surface, and
at least one support coupled to the second end of the at least one tube,
wherein the at least one tube is configured for guiding an air draft to the at least one lighting pad and the at least one support is configured to support the at least one lighting pad so that the at least one lighting pad substantially covers the outlet surface of the second end of the at least one tube and so that the air draft is concentrated so as to impinge the lighting pad.

14. The fire lighting system element of claim 1, further comprising an ash box with a front surface, wherein the air vent inlet is coupled to the front surface of the ash box.

15. The fire lighting system element of claim 2, further comprising an air draft regulation means for opening and closing the air vent inlet so that the air draft is modulated to regulate combustion processes in the grill oven.

16. The fire lighting system element of claim 3, wherein the air draft regulation means is coupled to the front surface of the ash box.

17. The fire lighting system element of claim 4, wherein the air draft regulating means is a door including one of a handle and a bolt.

18. The fire lighting system element of claim 1, wherein the at least one tube includes a first section extending from the first end in a substantially horizontal direction, a second section extending from the second end in a substantially vertical direction, and an elbow section coupled between the first section and the second section.

19. The fire lighting system element of claim 1, wherein the at least one support is a grid extending over the outlet surface of the second end of the at least one tube.

20. The fire lighting system element of claim 7, further comprising a first rim coupled to and extending around the second end of the at least one tube.

21. The fire lighting system element of claim 1, wherein the at least one tube includes at least two tubes each coupled to the air vent inlet.

22. The fire lighting system element of claim 9, further comprising an ash box configured to slidably engage the grill oven and having a front surface, wherein the air vent inlet is coupled to the front surface of the ash box.

23. A method of lighting a fire in a grill oven comprising the steps of
placing a lighting pad on a support at a second end of at least one tube included in a fire lighting system element,
lighting the lighting pad with a fire source,
positioning the second end of the at least one tube and the lighting pad below a combustion rack supporting material to be ignited inside the grill oven.

24. The method of claim 11 further comprising the steps of opening an ash drawer by sliding the ash drawer out from the grill oven and closing an ash drawer by sliding the ash drawer in to the grill oven.

25. The method of claim 12 wherein an air vent inlet of the fire lighting system element is coupled to a front surface of the ash drawer.

26. A grill oven comprising
a grill box having a door,
a combustion rack situated inside the grill box and operable to support combustion material,
a grill rack situated above the combustion rack in the grill box and operable to support food stuffs, and
a fire lighting system element including a first tube with a first end and a second end, an air vent inlet coupled to the first end of the first tube and in communication with air outside the grill oven, and a first support coupled to the second end of the first tube,
wherein the fire lighting system element is situated below the combustion rack inside the grill oven, the first tube is configured to receive air through the air vent inlet from outside the grill oven and to direct the air from outside the grill oven to the first support inside the grill oven, and the first support is operable to support a lighting pad.

27. The grill oven of claim 14, wherein the fire lighting system element further includes an ash drawer with a front surface and the air vent inlet is coupled to the front surface of the ash drawer.

28. The grill oven of claim 15, wherein the fire lighting system element also includes a second tube with a first end and a second end and the first end of the second tube is coupled to the air vent inlet.

29. The grill oven of claim 16, wherein the fire lighting system element also includes a second support coupled to the second end of the second tube and the first support and the second support are grids.

30. The grill oven of claim 17, wherein the fire lighting system element also includes a first rim and a second rim, the first rim extending around and above the first support and the second rim extending around and above the second support.

31. The grill oven of claim 15, wherein the fire lighting system element is slidable relative to the grill box.

32. The grill oven of claim 15, wherein the fire lighting system element also includes a door coupled to the air vent inlet and slidable relative to the air vent inlet to modulate the area of the air vent inlet in communication with air outside the grill oven.
